(19) United States
(12) Patent Application Publication
(10) Pub. No.: US 2013/0008685 A1
(43) Pub. Date: Jan. 10, 2013

(54) COVERING MATERIAL, COVERED RECTANGULAR ELECTRIC WIRE AND ELECTRICAL DEVICE

(75) Inventors: Kiichiro MATSUSHITA, Osaka (JP); Hiroomi HANAI, Osaka (JP); Kazunori HAYASHI, Fukui (JP); Jun FUJIKI, Fukui (JP); Akihiro OOHASHI, Fukui (JP); Kayoko TAKAYANAGI, Fukui (JP); Kazumasa MUKOBATA, Fukui (JP)

(73) Assignees: NITTO SHINKO CORPORATION, Sakai-shi (JP); NITTO DENKO CORPORATION, Osaka (JP)

(21) Appl. No.: 13/543,344

(22) Filed: Jul. 6, 2012

(30) Foreign Application Priority Data
Jul. 7, 2011 (JP) 2011-151056

(51) Int. Cl. H01B 7/00; H01B 17/00

(52) U.S. Cl. 174/110 R; 174/137 R

(57) ABSTRACT

Provided is a covering material, which includes a backing having an upper surface and a lower surface opposite to the upper surface, and a viscoelastic layer formed on the upper surface of the backing, in which the covering material is a covering material for covering a rectangular electric wire, and an adhesive force of the viscoelastic layer to the lower surface of the backing as measured by peeling at a peeling angle of 180° and a tensile rate of 300 mm/min is 0.05 N/20 mm or more and 10 N/20 mm or less. A covered rectangular electric wire includes the covering material and a rectangular electric wire covered with the covering material. An electrical device is produced by using the covered rectangular electric wire.

### CROSS REFERENCE TO RELATED APPLICATION

The present application claims priority of Japanese Patent Application No. 2011-151056, which is incorporated in the specification of the present application by reference.

### BACKGROUND OF THE INVENTION

1. Field of the Invention

The present invention relates to a covering material, a covered rectangular electric wire and an electrical device.

2. Description of the Related Art

In coil devices such as rotary devices and magnets to be used in electrical devices, there have been used covered rectangular electric wires obtained by covering rectangular electric wires with insulating covering materials. As the rectangular electric wires, there have hitherto been used wires made of copper, copper alloys, aluminum, aluminum alloys, and combinations of two or more of these metals; recently, for example, bismuth-based, yttrium-based and niobium-based superconducting wires have been used.

Examples of such a covered rectangular electric wire obtained by covering a rectangular electric wire with an insulating covering material include a covered rectangular electric wire disclosed in Japanese Patent Laid-Open No. 2000-4552. Japanese Patent Application Laid-Open No. 2000-4552 discloses a covering of naked rectangular electric wires arranged in parallel to each other with an insulating film tape by spirally winding the insulating film tape around the naked rectangular electric wires.

### PRIOR ART DOCUMENTS

### Patent Documents

Patent Document 1; Japanese Patent Application Laid-open No. 2000-4552

### SUMMARY OF THE INVENTION

However, in the covered rectangular electric wire of the Patent Document 1, for the purpose of increasing the insulation property of the naked rectangular electric wires, it is necessary to provide a lap portion formed by partial overlap of the insulating film tape with itself; sometimes a space occurs in the lap portion, or sometimes the insulating film tape dose not sufficiently adhere to the naked rectangular electric wires and hence the lap portion includes air bubbles. Electric field is concentrated in a portion in which such a space or such air bubbles are formed, and feeble discharge occurs in such a portion. This phenomenon is referred to as partial discharge, and offers a problem such that the partial discharge degrades the insulating film tape, and a long-term use of the insulating film tape sometimes results in dielectric breakdown to degrade the properties of the covered rectangular electric wire.

In particular, as has been verified by the present inventors, when a superconducting wire is used as a rectangular electric wire, because the superconducting wire is used in liquid nitrogen, the decrease of the partial discharge onset voltage due to the air bubbles penetrating into the lap portion is remarkable. Accordingly, the use of a superconducting wire as the rectangular electric wire also offers a problem such that the properties of the covered rectangular electric wire is degraded due to the partial discharge ascribable to the air bubbles or the space in the lap portion.

For the purpose of suppressing the degradation of the properties of the covered rectangular electric wire, a possible technique is such that the width of the lap portion is increased and the occurrence of the air bubbles or the space in the lap portion is suppressed. However, in the case where the width of the lap portion, namely, the overlap width of the insulating film tape is wide, when the insulating film tape is spirally wound around the naked rectangular electric wire, the length of the naked rectangular electric wire which can be covered with a single piece of the insulating film tape wound therearound becomes short.

For the purpose of suppressing the degradation of the properties of the covered rectangular electric wire, another possible technique is such that the angle between the extension direction of the naked rectangular electric wire and the winding direction of the insulating film tape is made larger to suppress the occurrence of the air bubbles and the space in the lap portion. However, also in this case, when the insulating film tape is spirally wound around the naked rectangular electric wire, the length of the naked rectangular electric wire which can be covered with a single piece of the insulating film tape wound therearound becomes short.

When the length of the naked rectangular electric wire which can be covered with a single piece of the insulating film tape wound therearound becomes short, the length of the rectangular electric wire which is covered with a single piece of the insulating film tape becomes short, and hence when an electrical device is produced by using such covered rectangular electric wires, the number of the joints between the covered rectangular electric wires is increased. At the joints between the covered rectangular electric wires, the properties of the electrical device are degraded due to the factors such as the decrease of the strength and the increase of the resistance in the joints.

In view of the above-described problems, an object of the present invention is to provide a covering material capable of suppressing the degradation of the properties thereof, which degradation is caused by covering a rectangular electric wire with the covering material and capable of covering a rectangular electric wire over an extended length. Another object of the present invention is to provide a covered rectangular electric wire and an electrical device in each of which the degradation of the properties is suppressed.

The present inventors have made a diligent study on the means for establishing the condition that in the case where a rectangular electric wire is spirally covered with a covering material, even when the angle (winding angle) between the extension direction of the rectangular electric wire and the winding direction of the covering material is set to be small and the width of the lap portion is set to be small, the occurrence of the air bubbles and the space in the lap portion can be suppressed and the degradation of the properties of the covered rectangular electric wire can be suppressed, and at the same time, the length of the rectangular electric wire, over which the rectangular electric wire is covered with the covering material can be extended; and consequently, the present inventors have perfected the present invention by discovering that the adhesive force in the lap portion is important.

Specifically, according to the present invention, there is provided a covering material, which includes: a backing having an upper surface and a lower surface opposite to the upper surface; and a viscoelastic layer formed on the upper surface of the backing, in which the covering material is a covering material for covering a rectangular electric wire; and an adhesive force of the viscoelastic layer to the lower surface (self-back surface) of the backing as measured by peeling at a peeling angle of 180° and a tensile rate of 300 mm/min is 0.05 N/20 mm or more and 10 N/20 mm or less.

According to the covering material of the present invention, the adhesive force to the self-back surface is 0.05 N/20 mm or more, and hence the adhesive force between the backing covering the rectangular electric wire and the viscoelastic layer superposed on the backing is large; accordingly, even when the winding angle is set to be small and the width of the lap portion is set to be small, the formation of the space and the air bubbles in the lap portion can be suppressed. Accordingly, it is possible to provide a covering material, capable of suppressing the occurrence of the partial discharge when the rectangular electric wire is covered with the covering material, and hence capable of suppressing the degradation of the properties of the covered rectangular electric wire and at the same time, capable of covering the rectangular electric wire over an extended length.

When the adhesive force to the self-back surface is 10 N/20 mm or less, in the case where the covering material is wound in a roll shape, the unreeling force is not too large, and hence the covering material can be unreeled. Thus, it becomes possible to coat the rectangular electric wire with the covering material.

In the covering material, the viscoelastic layer preferably contains a silicone-based viscoelastic composition.

The silicone-based viscoelastic composition is excellent in cold resistance, radiation resistance, heat resistance and corrosion resistance, and hence can improve the properties of the viscoelastic layer. Consequently, when a rectangular electric wire is covered, the properties thereof can be more suppressed.

In the covering material, the backing preferably has a thickness of 5.0 μm or more and 25.0 μm or less.

When the thickness of the backing is 5.0 μm or more, the strength of the covering material can be improved. When the thickness of the backing is 25.0 μm or less, it is possible to increase the density of the rectangular electric wire in the covered rectangular electric wire formed when the rectangular electric wire is covered with the covering material, and accordingly it is possible to more suppress the degradation of the properties of the covered rectangular electric wire.

A covered rectangular electric wire of the present invention includes a covering material and a rectangular electric wire covered with the covering material.

According to the covered rectangular electric wire of the present invention, because the covered rectangular electric wire includes the covering material having the adhesive force of the viscoelastic layer to the self-back surface of 0.05 N/20 mm or more and 10 N/20 mm or less, the formation of the space and the air bubbles in the lap portion can be suppressed even when the winding angle is set to be small and the width of the lap portion is set to be small. Consequently, it is possible to provide a covered rectangular electric wire suppressed in the degradation of the properties thereof.

In the covered rectangular electric wire, preferably the rectangular electric wire is a superconducting wire.

Since the superconducting wire is used at low temperatures, the occurrence of the air bubbles and the space in the lap portion remarkably decrease the partial discharge onset voltage. According to the covered rectangular electric wire of the present invention, because the covered rectangular electric wire includes the covering material having the adhesive force of the viscoelastic layer to the self-back surface of 0.05 N/20 mm or more and 10 N/20 mm or less, the formation of the space and the air bubbles in the lap portion can be suppressed. Accordingly, the present invention can preferably use a superconducting wire as the rectangular electric wire.

An electrical device of the present invention is produced by using any of the aforementioned covered rectangular electric wires.

The electrical device of the present invention is produced by using the covered rectangular electric wires each including a covering material allowing the extension of the length of the covered rectangular electric wire being covered with a single piece of the covering material while the high properties of the covered rectangular electric wire are being maintained. Consequently, the number of the joints between the covered rectangular electric wires can be reduced, and hence the degradation of the properties of the electrical device due to the joints can be reduced. Accordingly, it is possible to provide the electrical device suppressed in the degradation of the properties thereof.

As described above, according to the present invention, it is possible to provide a covering material capable of suppressing the degradation of the properties thereof, which degradation is caused by covering the rectangular electric wire with the covering material, and capable of covering the rectangular electric wire over an extended length. The present invention can also provide the covered rectangular electric wire suppressed in the degradation of the properties thereof and the electrical device suppressed in the degradation of the properties thereof.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic side view illustrating a covering material in Embodiment 1 of the present invention;

FIG. 2 is a schematic cross-sectional view illustrating the covering material in Embodiment 1 of the present invention, and is an enlarged cross-sectional view of the region II in FIG. 1;

FIG. 3 is a schematic oblique perspective view illustrating a covered rectangular electric wire in Embodiment 2 of the present invention;

FIG. 4 is a schematic plan view illustrating the covered rectangular electric wire in Embodiment 2 of the present invention;

FIG. 5 is a schematic cross-sectional view, along the V-V line in FIGS. 3 and 4, illustrating the covered rectangular electric wire in Embodiment 2 of the present invention;

FIG. 6 is a cross-sectional view along the line VI-VI in FIG. 4 schematically illustrating the covered rectangular electric wire in Embodiment 2 of the present invention;

FIG. 7 is a cross-sectional view along the line VII-VII in FIG. 4 schematically illustrating the covered rectangular electric wire in Embodiment 2 of the present invention;

FIG. 8 is a schematic oblique perspective view illustrating a coil as an example of an electrical device in Embodiment 3 of the present invention;

FIG. 9 is a schematic view illustrating the measurement apparatus for measuring the partial discharge onset voltage in Examples 1 and 2; and

FIG. 10 is a schematic view illustrating the measurement apparatus for measuring the dielectric breakdown voltage in Examples 1 and 2.

### DETAILED DESCRIPTION OF THE PREFERRED EMBODIMENTS

Hereinafter, the embodiments of the present invention are described with reference to the accompanying drawings. Hereinafter, the same symbols are attached to the same or corresponding parts in the drawings, of which the descriptions are not repeated.

### Embodiment 1

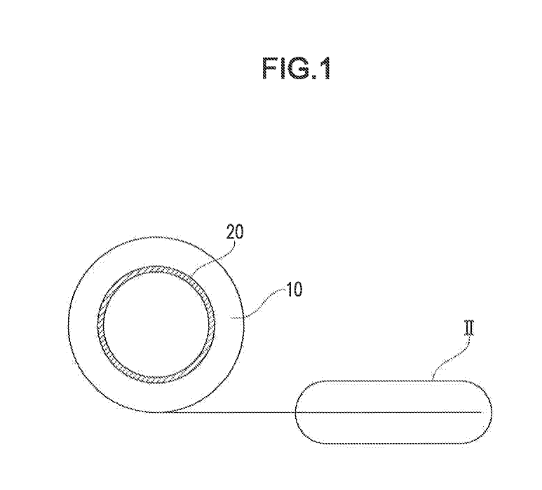

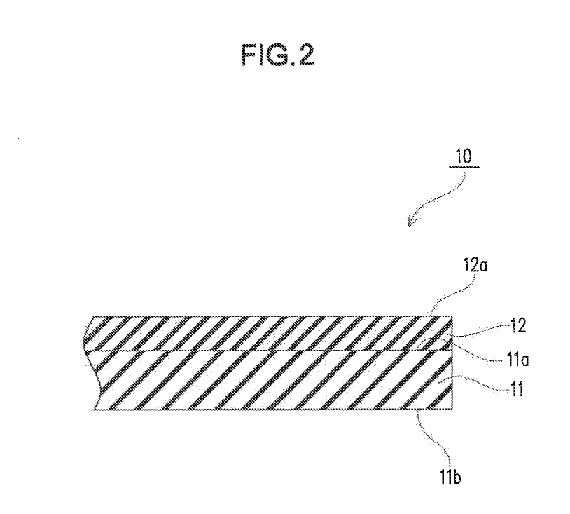

With reference to FIGS. 1 and 2, the covering material in one embodiment of the present invention is described. As shown in FIGS. 1 and 2, the covering material 10 in Embodiment 1 of the present invention is a covering material for covering a rectangular electric wire.

As shown in FIG. 1, the covering material 10 in the present embodiment is of a tape shape, and is, for example, wound around a winding core 20 in a roll shape. The covering material 10 is not limited to a tape shape, but may also take any other shapes such as a sheet shape and a film shape.

As shown in FIG. 2, the covering material 10 includes a backing 11 having an upper surface 11a and a lower surface 11b opposite to the upper surface 11a, and a viscoelastic layer 12 formed on the upper surface 11a of the backing 11. Another layer may be further formed between the backing 11 and the viscoelastic layer 12. On the upper surface 12a of the viscoelastic layer 12, a release liner (not shown) for protecting the upper surface 12a may also be formed. Preferably, no viscoelastic layer 12 is formed on the lower surface 11b of the backing 11.

The backing 11 is not particularly limited as long as the backing 11 is of an insulator; however, the backing 11 preferably has radiation resistance and heat resistance. Examples of such a backing 11 include polyimide resin, polyether resin, polyether ether ketone resin, polyether imide resin and polyamide-imide resin. These resins may be used each alone or as mixtures of two or more thereof. Among these resins, in particular, polyimide resin is preferably used as the backing 11. Polyimide resin is a nonflammable material as well as a heat resistant material; hence, because of having an excellent flame retardancy as an insulating material used in an electrical device, polyimide resin has excellent properties as the backing 11 of the covering material 10 of the present embodiment.

Polyimide resin can be obtained by heretofore well known or conventional methods. For example, polyimide can be obtained by allowing an organic tetracarboxylic acid dianhydride and a diamino compound (diamine) to react with each other to synthesize a polyimide precursor (polyamide acid), and by dehydrating and ring-closing the polyimide precursor.

Examples of the organic tetracarboxylic acid dianhydride include: pyromellitic acid dianhydride (PMDA), 3,3′,4,4′-biphenyl tetracarboxylic acid dianhydride (BPDA), 4,4′-oxydiphthalic acid anhydride (ODPA), 2,2-bis(2,3-dicarboxyphenyl)-1,1,1,3,3,3-hexafluoropropane dianhydride, 2,2-bis(3,4-dicarboxyphenyl)-1,1,1,3,3,3-hexafluoropropane dianhydride, 3,3′,4,4′-benzophenone tetracarboxylic acid dianhydride, bis(3,4-dicarboxyphenyl)ether dianhydride and bis(3,4-dicarboxyphenyl)sulfone dianhydride. These organic tetracarboxylic acid dianhydrides may be used each alone or as mixtures of two or more thereof.

Among the aforementioned organic tetracarboxylic acid dianhydrides, when importance is attached to flexibility, the compounds having an ether bond such as ODPA are preferable. Among the aforementioned organic tetracarboxylic acid dianhydrides, when importance is attached to strength, PMDA having a rigid structure can be used, and when the balance between strength and flexibility is considered, BPDA can be used.

Examples of the diamino compound include m-phenylenediamine, p-phenylenediamine, 3,4-diaminodiphenyl ether, 4,4′-diaminodiphenyl ether, 4,4′-diaminodiphenyl sulfone, 3,3′-diaminodiphenyl sulfone, 2,2-bis(4-aminophenoxyphenyl)propane, 2,2-bis(4-aminophenoxyphenyl)hexafluoropropane, 1,3-bis(4-aminophenoxy)benzene, 1,4-bis(4-aminophenoxy)benzene, 2,4-diaminotoluene, 2,6-diaminotoluene, diaminodiphenylmethane, 2,2′-dimethyl-4,4′-diaminobiphenyl and 2,2′-bis(trifluoromethyl)-4,4′-diaminobiphenyl. These diamino compounds may be used each alone or as mixtures of two or more thereof.

For the polyimide resin used in the present embodiment, it is preferable to use pyromellitic acid dianhydride or 3,3′,4,4′-biphenyl tetracarboxylic acid dianhydride as an organic tetracarboxylic acid dianhydride, and p-phenylenediamine or 4,4′-diaminodiphenyl ether as a diamino compound. As such polyimide resins, commercially available resins such as “Kapton (registered trademark)” (manufactured by Du Pont-Toray Co., Ltd.), “Upilex (registered trademark)” (manufactured by Ube Industries, Ltd.) and “Apical (registered trademark)” (manufactured by Kaneka Corp.) can also be used.

The backing 11 has a thickness of preferably 5.0 μm or more and 25.0 μm or less, more preferably 7.0 μm or more and 15.0 μm or less and furthermore preferably 10.0 μm or more and 12.5 μm or less. When the thickness falls within this range, a sufficient insulation property can be ensured, and when a rectangular electric wire is covered, the function of the rectangular electric wire can be sufficiently exhibited.

Specifically, when the thickness of the backing 11 is 25.0 μm or less, it is possible to increase the wire occupation rate of the rectangular electric wire in the covered rectangular electric wire formed when the rectangular electric wire is covered with the covering material, and hence it is possible to more suppress the degradation of the properties of the covered rectangular electric wire. When the thickness of the backing 11 is 15.0 μm or less, it is possible to further suppress the degradation of the properties of the covered rectangular electric wire. When the thickness of the backing 11 is 12.5 μm or less, it is possible to furthermore suppress the degradation of the properties of the covered rectangular electric wire.

On the other hand, when the thickness of the backing 11 is 5.0 μm or more, it is possible to increase the insulation property of the covered rectangular electric wire formed when the rectangular electric wire is covered with the covering material 10, and hence it is possible to suppress the occurrence of the dielectric breakdown during operation. When the thickness of the backing 11 is 7.0 μm or more, it is possible to more suppress the occurrence of the dielectric breakdown. When the thickness of the backing 11 is 10.0 μm or more, it is possible to furthermore suppress the occurrence of the dielectric breakdown.

For the purpose of improving the anchoring capability of the backing 11 with the below described viscoelastic layer 12, the backing 11 in the present embodiment may be subjected to a chemical treatment such as a sputtering etching treatment, a corona treatment or a plasma treatment, or alternatively may be coated with a primer.

The backing 11 in the present embodiment may be formed of a layer or a plurality of layers.

The viscoelastic layer 12 has an adhesive force (peeling angle: 180°, tensile rate: 300 mm/min), to the lower surface 11b (self-back surface) of the backing 11, of 0.05 N/20 mm or more and 10 N/20 mm or less, preferably 0.2 N/20 mm or more and 6.0 N/20 mm or less and more preferably 1.7 N/20 mm or more and 3.6 N/20 mm or less.

When the adhesive force to the self-back surface is less than 0.05 N/20 mm, the adhesive force between the backing 11 covering the rectangular electric wire and the viscoelastic layer 12 superposed on the backing (on the lower surface 11b) is too small, the space and the air bubbles are formed in the lap portion when the winding angle is small or the width of the lap portion is small, and hence when the rectangular electric wire is covered, degradation of the properties of the covered rectangular electric wire, such as the occurrence of partial discharge occurs. When the winding angle is increased or the width of the lap portion is increased, the covering material cannot cover the rectangular electric wire over an extended length over which a single piece of the covering material can cover the rectangular electric wire. When the adhesive force to the self-back surface is 0.2 N/20 mm or more, it is possible to suppress the degradation of the properties, and at the same time it is possible to extend the length. When the adhesive force to the self-back surface is 1.7 N/20 mm or more, it is possible to more suppress the degradation of the properties, and at the same time it is possible to more extend the length.

On the other hand, when the adhesive force to the self-back surface exceeds 10 N/20 mm, in the case where the covering material 10 is wound in a roll shape as in the present embodiment, the unreeling force is too large, hence the covering material 10 cannot be unreeled, and hence it is impossible to cover the rectangular electric wire with the covering material 10. Also, when the adhesive force to the self-back surface exceeds 10 N/20 mm, in the case where a coil is formed by using the covering material and an epoxy resin or the like is introduced into the voids and solidified, the epoxy resin is difficult to adhere to the covering material, and thus, the covering material 10 cannot be used in electrical devices such as a coil. When the adhesive force to the self-back surface is 6.0 N/20 mm or less, the unwinding stability is obtained, and hence it is possible to cover the rectangular electric wire with the covering material. When the adhesive force to the self-back surface is 3.6 N/20 mm or less, the unwinding stability is sufficiently obtained, and hence it is possible to cover the rectangular electric wire with the covering material.

Here, the adhesive force to the self-back surface means a force required for the following peeling off: a viscoelastic layer 12 of 20 mm in width is attached and pressure bonded to the self-back surface and then the peeling off of the viscoelastic layer 12 is performed at a peeling angle of 180° and a tensile rate of 300 mm/min; the larger the numerical value is, the larger the adhesive force to the self-back surface is.

The aforementioned adhesive force to the self-back surface can be attained, for example, by regulating the composition of the viscoelastic layer 12. For example, when a silicone-based viscoelastic composition is used as the viscoelastic layer 12, by regulating the mixing ratio between a silicone rubber and a silicone resin, the adhesive force to the self-back surface can be regulated; specifically, the adhesive force can be increased by increasing the mixing amount of the silicone resin. More specifically, for the purpose of regulating the adhesive force of the viscoelastic layer 12 to the self-back surface (peeling angle: 180°, tensile rate: 300 mm/min) to fall within a range of 0.05 N/20 mm or more and 10 N/20 mm or less, the mixing ratio (weight ratio) between the silicone rubber and the silicone resin is set approximately at silicone rubber:silicone resin=95:5 to 30:70.

The viscoelastic layer 12 has an adhesive force (peeling angle: 180°, tensile rate: 300 mm/min) to a SUS304 steel plate of preferably 0.28 N/20 mm or more and 8.0 N/20 mm or less and more preferably 2.5 N/20 mm or more and 5.9 N/20 mm or less.

When the adhesive force to the SUS304 steel plate is 0.28 N/20 mm or more, the adhesive force of the viscoelastic layer 12 is large, hence the covering material sufficiently adheres to the rectangular electric wire at room temperature, and the rectangular electric wire can be covered with the covering material in such a way that the space and the air bubbles formed in the lap portion are suppressed; thus, the degradation of the properties of the covered rectangular electric wire can be more suppressed, and at the same time, when a rectangular electric wire is covered with a single piece of the covering material, the covering material can cover the rectangular electric wire over an extended length. When the adhesive force to the SUS304 steel plate is 2.5 N/20 mm or more, the degradation of the properties of the covered rectangular electric wire can be further suppressed, and at the same time, the covered rectangular electric wire can be more extended in length.

On the other hand, when the adhesive force to the SUS304 steel plate is 5.9 N/20 mm or less, in the case where the covering material is wound in a roll shape as in the present embodiment, the covering material can be easily unreeled, and at the same time, when the rectangular electric wire is spirally covered with the covering material, it is possible to suppress the elongation of the covering material 10 and the occurrence of the warping, twisting or the like in the rectangular electric wire.

Here, the adhesive force to the SUS304 steel plate means a force required for the following peeling off: a viscoelastic layer 12 of 20 mm in width is attached and pressure bonded to the SUS304 steel plate and then the peeling off of the viscoelastic layer 12 is performed at a peeling angle of 180° and a tensile rate of 300 mm/min; the larger the numerical value is, the larger the adhesive force to the SUS304 steel plate is.

The aforementioned adhesive force to the SUS304 steel plate can be attained, for example, by regulating the composition of the viscoelastic layer 12. For example, when a silicone-based viscoelastic composition is used as the viscoelastic layer, by regulating the mixing ratio between a silicone rubber and a silicone resin, the adhesive force to the SUS304 steel plate can be regulated; specifically, the adhesive force can be increased by increasing the mixing amount of the silicone resin. More specifically, for the purpose of regulating the adhesive force of the viscoelastic layer 12 to the SUS304 steel plate (peeling angle: 180°, tensile rate: 300 mm/min) to fall within a range of 0.28 N/20 mm or more and 5.9 N/20 mm or less, the mixing ratio (weight ratio) between the silicone rubber and the silicone resin is set approximately at silicone rubber:silicone resin=90:10 to 50:50.

The viscoelastic layer 12 includes a base polymer constituting a viscoelastic material. Such a base polymer is not particularly limited, and base polymers appropriately selected from heretofore known base polymers can be used as such a base polymer; examples of such a base polymer include acrylic-based polymers, rubber-based polymers, vinyl alkyl ether-based polymers, silicone-based polymers, polyester-based polymers, polyamide-based polymers, urethane-based polymers, fluorine-based polymers and epoxy-based polymers. These base polymers may be used each alone or as mixtures of two or more thereof. Among these base polymers, it is preferable to use a silicone-based polymer as the viscoelastic layer 12, from the viewpoint of being excellent in cold resistance, radiation resistance, heat resistance and corrosion resistance. In other words, the viscoelastic layer 12 preferably includes a silicone-based polymer-containing viscoelastic composition (silicone-based viscoelastic composition), and preferably the viscoelastic layer 12 is mainly composed of a silicone-based viscoelastic composition with the balance being composed of inevitable impurities.

The silicone-based viscoelastic composition includes a cross-linking structure of a mixture mainly composed of a silicone rubber and a silicone resin.

As the silicone rubber, for example, an organopolysiloxane including dimethylsiloxane as a main constitutional unit can be preferably used. A vinyl group or other functional groups may be introduced into the organopolysiloxane if necessary. The weight average molecular weight of the organopolysiloxane is usually 180,000 or more, and is preferably 280,000 or more and 1,000,000 or less and more preferably 500,000 or more and 900,000 or less. These silicone rubbers may be used each alone or as mixtures of two or more thereof. When the weight average molecular weight is low, the gel fraction can be adjusted by regulating the amount of a cross-linking agent.

It is possible to preferably use, as the silicone resin, for example, an organopolysiloxane made of a copolymer having at least one unit selected from the M unit (R₃SiO_{1/2}), the Q unit (SiO₂), the T unit (RSiO_{3/2}) and the D unit (R₂SiO) (in these units, R represents a monovalent hydrocarbon group or a hydroxy group). The organopolysiloxane made of the copolymer may have one or more OH groups, and additionally, may also have various functional groups such as a vinyl group, as introduced therein, if necessary. The functional groups to be introduced may also be groups to cause cross-linking reactions. As the copolymer, the MQ resin composed of the M unit and the Q unit is preferable.

The mixing ratio (weight ratio) between the silicone rubber and the silicone resin is not particularly limited; however, the ratio silicone rubber:silicone resin is preferably approximately 100:0 to 20:80 and more preferably approximately 100:0 to 30:70. The silicone rubber and the silicone resin may also be simply mixed together or may also be used as a partial condensation product between the silicone rubber and the silicone resin.

The aforementioned mixture usually contains a cross-linking agent for the purpose of converting the mixture into a cross-linked structure. The gel fraction of the silicone-based viscoelastic composition can be regulated with a cross-linking agent.

The gel fraction of the viscoelastic layer 12 varies depending on the type of the silicone-based viscoelastic composition; the gel fraction of the viscoelastic layer 12 is generally preferably 20% or more and 99% or less and more preferably approximately 30% or more and 98% or less. The gel fraction falling within such a range offers an advantage that it is easy to establish the balance between adhesive force and retention force. Specifically, when the gel fraction is 99% or less, it is possible to suppress the occurrence of the decrease of the initial adhesive force to result in satisfactory sticking; when the gel fraction is 20% or more, a sufficient retention force is obtained, and hence the displacement of the covering material 10 can be suppressed.

The gel fraction (% by weight) of the silicone-based viscoelastic composition in the present embodiment is a value obtained as follows: a sample of a dry weight W₁ (g) is sampled from the silicone-based viscoelastic composition and immersed in toluene; then the insoluble matter of the sample is taken out from the toluene; then after drying the weight W₂ (g) of the insoluble matter is measured, and the gel fraction is derived from the formula (W₂/W₁)×100.

The silicone-based viscoelastic composition in the present embodiment can use the following generally used cross-linkages: a peroxide curing type cross-linkage due to a peroxide-based cross-linking agent and an addition reaction type cross-linkage due to a Si—H group-containing siloxane-based cross-linking agent.

The cross-linking reaction of the peroxide-based cross-linking agent is a radical reaction, and accordingly the cross-linking reaction is allowed to proceed usually at a high temperature of 150° C. or higher and 220° C. or lower. On the other hand, the cross-linking reaction between a vinyl group-containing organopolysiloxane and a siloxane-based cross-linking agent is an addition reaction, and accordingly the reaction usually proceeds at a low temperature of 80° C. or higher and 150° C. or lower. In the present embodiment, the addition reaction-type cross-linkage is preferable particularly from the viewpoint that the cross-linking can be completed at a low temperature in a short period of time.

As the peroxide-based cross-linking agent, various cross-linking agents having hitherto been used for the silicone-based viscoelastic composition can be used without any particular limitation. Examples of such a peroxide-based cross-linking agent include benzoyl peroxide, t-butylperoxy benzoate, dicumyl peroxide, t-butyl cumyl peroxide, t-butyl peroxide, 2,5-dimethyl-2,5-di-t-butylperoxy hexane, 2,4-dichlorobenzoyl peroxide, di-t-butylperoxy-diisopropyl benzene, 1,1-bis(t-butylperoxy)-3,3,5-trimethylcyclohexane and 2,5-dimethyl-2,5-di-t-butylperoxy hexyne-3. These peroxide-based cross-linking agents may be used each alone or as mixtures of two or more thereof. Usually, the used amount of the peroxide-based cross-linking agent is preferably 0.15 part by weight or more and 2 parts by weight or less and more preferably 0.5 part by weight or more and 1.4 parts by weight or less in relation to 100 parts by weight of the silicone rubber.

As the siloxane-based cross-linking agent, for example, a polyorganohydrogen siloxane having in the molecule thereof at least on average two or more hydrogen atoms bonded to the silicon atom is used. Examples of the organic group bonded to the silicon atom include an alkyl group, a phenyl group and a halogenated alkyl group; however, from the viewpoint of the easiness in synthesis and handling, a methyl group is preferable. The skeletal structure of siloxane may be any of linear chain, branched chain and annular structures; preferable among these is a linear chain structure.

The siloxane-based cross-linking agent is mixed in an addition amount such that the number of the hydrogen atoms bonded to the silicon atoms is preferably one or more and 30 or less and more preferably four or more and 17 or less in relation to one vinyl group in the silicone rubber and the silicone resin. When the number of the hydrogen atoms bonded to the silicon atoms is one or more, a sufficient cohesive force is obtained; when the number of the hydrogen atoms bonded to the silicon atoms is four or more, a more sufficient cohesive force is obtained; when the number of the hydrogen atoms bonded to the silicon atoms is 30 or less, the degradation of the adhesion property can be suppressed; and when the number of the hydrogen atoms bonded to the silicon atoms is 17 or less, the degradation of the adhesion property can be more suppressed.

When the siloxane-based cross-linking agent is used, usually a platinum catalyst is used; however, various other catalysts can also be used.

When the siloxane-based cross-linking agent is used, a vinyl group-containing organopolysiloxane is used as the silicone rubber, and the content of the vinyl group is preferably approximately 0.0001 mol/100 g or more and 0.01 mol/100 g or less.

Within a range not impairing the advantageous effects of the present invention, for example, the following heretofore known various additives can be appropriately mixed in the viscoelastic layer of the present invention, in addition to the aforementioned base polymer: a tackifier, a plasticizer, a dispersant, an antiaging agent, an antioxidant, a processing aid, a stabilizer, an antifoaming agent, a flame retardant, a thickener, a pigment, a softener and a filler.

The viscoelastic layer 12 has a thickness of preferably 1.0 μm or more and 25.0 μm or less and more preferably 3.0 μm or more and 15.0 μm or less. The thickness of the viscoelastic layer 12 falling within this range offers an advantage that an appropriate adhesiveness can be obtained.

Specifically, when the thickness of the viscoelastic layer 12 is 25.0 μm or less, it is possible to increase the wire occupation rate of the rectangular electric wire in the covered rectangular electric wire formed when the rectangular electric wire is covered with the covering material 10, and hence it is possible to more suppress the degradation of the properties of the covered rectangular electric wire. When the thickness of the viscoelastic layer 12 is 15.0 μm or less, it is possible to further suppress the degradation of the properties.

On the other hand, when the thickness of the viscoelastic layer 12 is 1.0 μm or more, it is possible to increase the degree of the adhesion to the rectangular electric wire, and hence it is possible to more suppress the gap formed between the rectangular electric wire and the covering material 10. When the thickness of the viscoelastic layer 12 is 3.0 μm or more, it is possible to furthermore suppress the gap formed between the rectangular electric wire and the covering material 10.

The covering material 10 has a thickness of preferably 13.0 μm or more and 40.0 μm or less, more preferably 15.5 μm or more and 40.0 μm or less. When the thickness of the covering material 10 is 13.0 μm or more, the covering material is sufficient in strength and excellent in handleability; when the thickness of the covering material 10 is 15.5 μm or more, the covering material is more sufficient in strength and more excellent in handleability. When the thickness of the covering material 10 is 40.0 μm or less, it is possible to increase the wire occupation rate of the rectangular electric wire in the covered rectangular electric wire formed when the rectangular electric wire is covered with the covering material, and hence it is possible to more suppress the degradation of the properties of the covered rectangular electric wire.

The covering material 10 preferably has a width of one or more times and two or less times the width of the rectangular electric wire to be covered, from the viewpoint that when the rectangular electric wire is covered with the covering material 10 spirally wound around the rectangular electric wire, it is possible to make narrow the width of the lap portion and it is possible to reduce the angle between the extension direction of the naked rectangular electric wire and the winding direction of the insulating film tape. The width of such a covering material 10 is, for example, preferably 1 mm or more and 80 mm or less, more preferably 1.5 mm or more and 60 mm or less and furthermore preferably 2 mm or more and 40 mm or less.

The covering material 10 is preferably a lengthy product because the covering of the rectangular electric wire with the covering material 10 is preferably free from the patching together portion corresponding to the connection portion in the covering of the rectangular electric wire. The length of such a covering material 10 is, for example, preferably 500 mm or more, more preferably 1000 mm or more and furthermore preferably 3000 mm or more. The covering material 10 of the present embodiment is wound in a roll shape around the winding core 20 to be retained; however, the covering material 10 of the present embodiment may also be retained as wound around a winding core 20 in a plurality of rows, namely, in so-called bobbin winding.

Next, with reference to FIGS. 1 and 2, the production method of the covering material 10 in the present embodiment is described.

First, as described above, the backing 11 having the upper surface 11a and the lower surface 11b opposite to the upper surface 11a is prepared.

Next, the viscoelastic layer 12 is formed on the upper surface 11a of the backing 11. The formation method of the viscoelastic layer 12 is not particularly limited; for example, the viscoelastic layer 12 can be formed by a method of coating the upper surface 11a of the backing 11 with a silicone-based viscoelastic composition.

Specifically, a solution prepared by dissolving, in a solvent such as toluene, the silicone-based viscoelastic composition including a silicone rubber, a silicone resin, a cross-linking agent, a catalyst and the like is applied to the upper surface 11a of the backing 11, and next, by heating the aforementioned mixture, the solvent is distilled off and cross-linking is performed. Examples of the formation method of the viscoelastic layer 12 including the silicone-based viscoelastic composition in the present embodiment include: an extrusion coating method based on roll coating, kiss-roll coating, gravure coating, reverse coating, roll brush coating, spray coating, dip roll coating, bar coating, knife coating, air-knife coating, curtain coating, lip coating or die coating.

By performing the foregoing steps, the covering material 10 shown in FIG. 2 can be produced. The production method of the covering material 10 is not particularly limited to the above-described method. When the covering material 10 is provided with a release liner, the covering material 10 may be produced, for example, by the following method.

Specifically, first, a release liner is prepared. Examples of the release liner include: paper; films of synthetic resins such as polyethylene, polypropylene and polyethylene terephthalate; and rubber sheet, paper, cloth, non-woven fabric, net, foam sheet and metal foil or laminate sheets of these.

Next, on the release liner, for example, the viscoelastic layer 12 including the silicone-based viscoelastic composition is formed. The formation method of the viscoelastic layer 12 is not particularly limited; however, when the viscoelastic layer 12 including the silicone-based viscoelastic composition to perform the addition reaction type cross-linking is formed by using toluene as the solvent, the heating temperature is, for example, preferably 80° C. or higher and 150° C. or lower and more preferably 100° C. or higher and 130° C. or lower. The heating temperature is not particularly limited as long as the heating temperature allows the solvent to be distilled off and allows the intended cross-linking reaction to proceed.

Next, the viscoelastic layer 12 formed on the release liner is transferred onto the backing 11. By performing the foregoing steps, the covering material 10 shown in FIG. 2 can be produced.

In the present embodiment, as shown in FIG. 1, a step of winding, around the winding core 20, the covering material 10 shown in FIG. 2 is further performed. This step may be omitted depending on the factors such as the shape of the covering material 10.

As described above, the covering material 10 in the present embodiment includes the backing 11 having the upper surface 11a and the lower surface 11b opposite to the upper surface 11a, and the viscoelastic layer 12 formed on the upper surface 11a of the backing 11, in which the covering material is a covering material for covering a rectangular electric wire, and an adhesive force of the viscoelastic layer 12 to the lower surface 11b (self-back surface) of the backing 11 as measured by peeling at a peeling angle of 180° and a tensile rate of 300 mm/min is 0.05 N/20 mm or more and 10 N/20 mm or less.

According to the covering material 10 in the present embodiment, the adhesive force to the self-back surface is 0.05 N/20 mm or more, thus the adhesive force between the backing 11 covering the rectangular electric wire and the viscoelastic layer 12 superposing on the backing 11 is large, and hence it is possible to suppress the formation of the space and the air bubbles in the lap portion even when the winding angle for the rectangular electric wire is set to be small and the width of the lap portion is set to be small. Consequently, when the rectangular electric wire is covered with the covering material, it is possible to suppress the occurrence of the partial discharge, and hence it is possible to realize the covering material 10 capable of suppressing the degradation of the properties of the covered rectangular electric wire and capable of covering the rectangular electric wire over an extended length.

The adhesive force to the self-back surface is 10 N/20 mm or less, hence when the covering material 10 is wound in a roll shape, the unreeling force is not too large, and accordingly it is possible to unreel the covering material 10. Thus, it is possible to cover the rectangular electric wire with the covering material 10.

### Embodiment 2

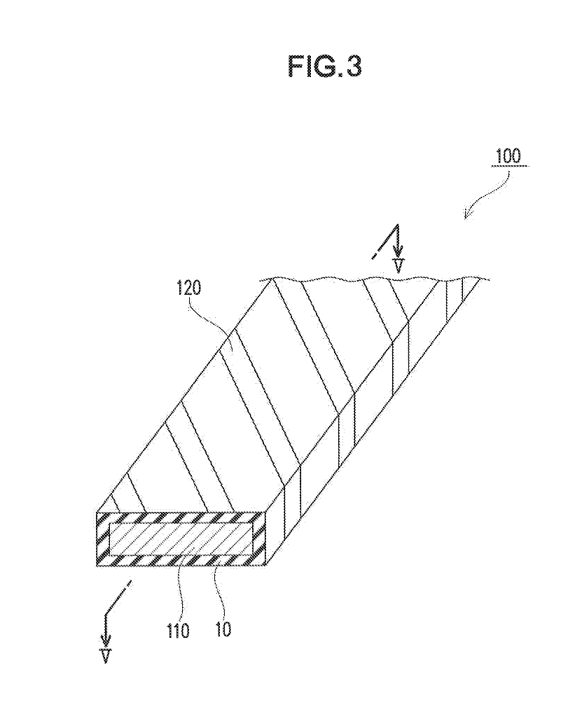

With reference to FIGS. 3 to 7, the covered rectangular electric wire 100 in Embodiment 2 of the present invention is described. As shown in FIG. 3, the covered rectangular electric wire 100 in the present embodiment includes the covering material 10 of Embodiment 1 and a rectangular electric wire 110 covered with this covering material 10.

The mode of the covering of the rectangular electric wire 110 with the covering material 10 is not particularly limited; the covering material 10 may be spirally wound, or may be wound in such a way that the rectangular electric wire 110 runs along the lengthwise direction of the covering material 10 (so as to be attached in the longitudinal direction). As shown in FIGS. 3 to 5, the rectangular electric wire 110 in the present embodiment is covered with the covering material 10 in such a way that the covering material 10 is spirally wound around the rectangular electric wire 110.

Here, a preferable mode of spirally winding the rectangular electric wire 110 with the covering material 10 is described with reference to FIGS. 3 to 7.

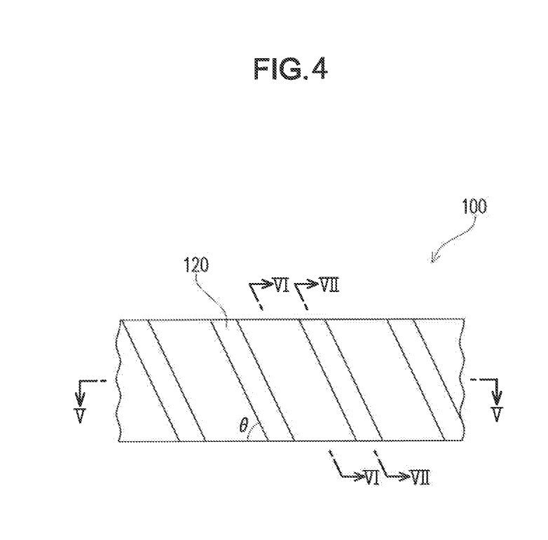

As shown in FIG. 4, the angle θ (also referred to as the winding angle θ or the winding-around angle θ) between the extension direction of the rectangular electric wire 110 and the winding direction of the covering material 10 is preferably less than 60° and more preferably 20° or less. The smaller the angle θ is, the longer the length of the rectangular electric wire 110 which can be covered with a single piece of the covering material 10 becomes.

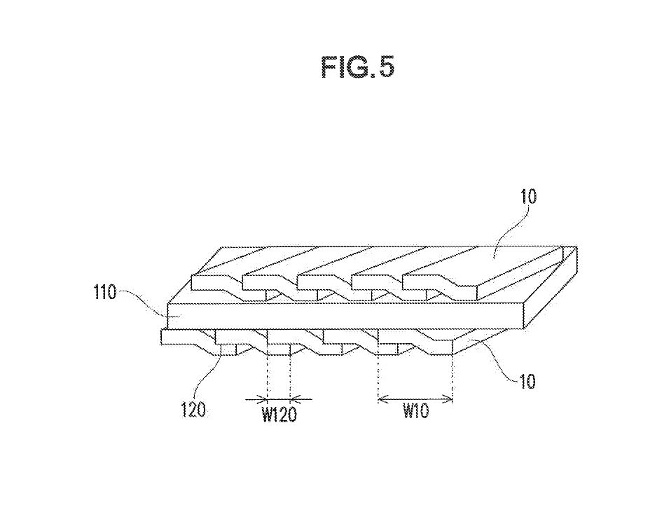

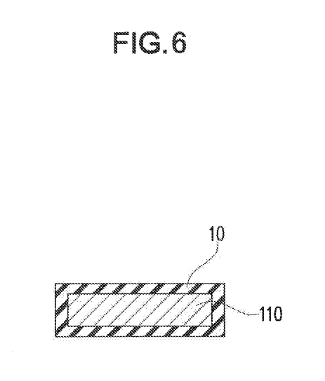

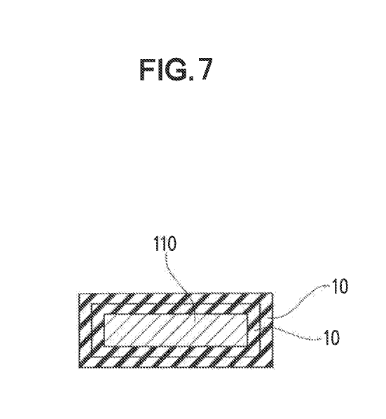

As shown in FIGS. 3 to 5, the covering material 10 is spirally wound around the rectangular electric wire 110 in such a way that the covering material 10 partially overlaps with itself in a half lap manner. As shown in FIGS. 5 and 6, the rectangular electric wire 110 is singly covered with the covering material 10 in the area in which no lap portion 120 is formed; and as shown in FIGS. 5 and 7, the rectangular electric wire 110 is doubly covered with the covering material 10 in the area in which the lap portion 120 is formed. Accordingly, the provision of the lap portion 120 enables the increase of the insulation property of the rectangular electric wire 110.

As shown in FIG. 5, the width W120 of the lap portion 120 (also referred to as the overlap width or the creeping distance) is preferably less than 40% and more preferably 30% or less of the width W10 of the covering material 10. The larger the width W120 of the lap portion 120 is, the more difficult the pass of the electric current through the covering material 10 is, and hence the discharge can be suppressed and the dielectric breakdown voltage can be improved. However, in the present embodiment, the viscoelastic layer 12 adheres to the lower surface 11b of the backing 11 in the lap portion 120, and hence even when the width W120 of the lap portion 120 is small, the pass of the electric current through the covering material 10 is difficult. When the width W120 of the lap portion 120 can be designed to be small as described above, the length of the rectangular electric wire 110 which can be covered with a single piece of the covering material 10 as wound therearound can be designed to be long.

Next, the rectangular electric wire 110 is described.

The rectangular electric wire 110 is a tape-shaped wire, and each of the edges thereof may be angular or curved (rounded).

The rectangular electric wire 110 is not particularly limited, and heretofore well known rectangular electric wires can be used; as the materials for such wires, for example, wires made of copper, copper alloy, aluminum, aluminum alloy, or combinations of two or more of these metals can be used. As the rectangular electric wire 110, rectangular electric wires made of various superconducting materials such as a bismuth-based, an yttrium-based and a niobium-based superconducting material can also be used.

An example of a specific dimension of the rectangular electric wire 110 is such that the thickness is 1 mm or more and 10 mm or less, the width is 1 mm or more and 20 mm or less, and the aspect ratio (the ratio width/thickness in the cross-sectional shape) is approximately 1 or more and 60 or less.

Next, the production method of the covered rectangular electric wire 100 in the present embodiment is described.

First, according to Embodiment 1, the covering material 10 is produced.

Next, the rectangular electric wire 110 is prepared, and as shown in FIGS. 3 to 7, the covering material 10 is spirally wound around the rectangular electric wire 110 in a manner partially overlapping with itself in a half lap manner. Specifically, the covering material 10 is arranged in such a way that an area of the viscoelastic layer 12 is brought into contact with the rectangular electric wire 110, and the rest area of the viscoelastic layer 12 is brought into contact with an area of the lower surface 11b of the backing 11 of the covering material 10.

In this step, the rectangular electric wire 110 is covered with the covering material 10 in such a way that the angle θ between the extension direction of the rectangular electric wire 110 and the winding direction of the covering material 10 is preferably less than 60° and more preferably 20° or less. Additionally, the rectangular electric wire 110 is covered with the covering material 10 in such a way that the width W120 of the lap portion 120 is preferably less than 40% and more preferably 30% or less of the width W10 of the covering material 10.

In the case where the covering material 10 is provided with a release liner, when the covering material 10 is wound around the rectangular electric wire 110, the covering material 10 is wound around the rectangular electric wire 110 while the release liner and the upper surface 12a of the viscoelastic layer 12 are being released from each other.

By performing the foregoing steps, the covered rectangular electric wire 100 of the present embodiment shown in FIGS. 3 to 7 can be produced.

As described above, the covered rectangular electric wire 100 in the present embodiment includes the covering material 10 of Embodiment 1 and the rectangular electric wire 110 covered with the covering material 10.

According to the covered rectangular electric wire 100 in the present embodiment, the covered rectangular electric wire 100 includes the covering material 10 in which the adhesive force of the viscoelastic layer 12 to the lower surface 11b (self-back surface) of the backing 11 is 0.05 N/20 mm or more and 10 N/20 mm or less, and hence even when the winding angle θ is set to be small and the width W120 of the lap portion 120 is set to be small, the viscoelastic layer 12 strongly adheres in the lap portion 120 to the lower surface 11b of the backing 11, and accordingly it is possible to suppress the formation of the space and the air bubbles in the lap portion 120. Thus, even when the winding angle θ is set to be small and/or the overlap width is set to be small, it is possible to realize the covered rectangular electric wire 100 in which the degradation of the properties of the covered rectangular electric wire 100 is suppressed and the covered rectangular electric wire 100 is extended in length.

### Embodiment 3

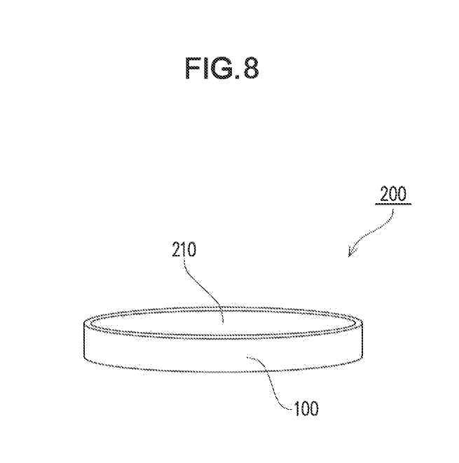

With reference to FIG. 8, description is made on a coil 200 as an example of the electrical device in Embodiment 3 of the present invention. As shown in FIG. 8, the coil 200 of the present embodiment includes a reel 210 and the covered rectangular electric wire 100 of Embodiment 2 wound around the reel 210.

The reel 210 is not particularly limited as long as the covered rectangular electric wire 100 can be wound around the reel 210; however, examples of the reel 210 include a cylindrical type and a racetrack type. The covered rectangular electric wire 100 may be a string, or may be formed of a plurality of strings connected to each other according to the required length. The coil may be formed of a plurality of laminated coils 200.

The production method of the coil 200 in Embodiment 3 includes a step of preparing the reel 210, and a step of winding the covered rectangular electric wire 100 around the reel 210.

In the present embodiment, the coil 200 is described as an example of the electrical device; however, the electrical device is not limited to the coil 200. Examples of the electrical device include: an insulating coil, a superconducting coil, a superconducting magnet, a superconducting cable and an electric power storage apparatus.

As described above, the coil 200 as an example of the electrical device of the present embodiment is produced by using the covered rectangular electric wire 100 of Embodiment 2.

The coil 200 as an example of the electrical device of the present invention is produced by using the covered rectangular electric wires 100 each including the covering material 10, capable of covering the rectangular electric wire over an extended length over which a single piece of the covering material 10 can cover the rectangular electric wire, while the high properties of the covered rectangular electric wire 100 are being maintained. Consequently, in the coil 200, the number of the joints between the covered rectangular electric wires 100 can be reduced. In general, the joints between the covered rectangular electric wires 100 are poorer in strength, insulation property, resistance and the like than the other portions, and hence when the number of the joints can be reduced, and the degradation of the properties of the electrical device due to the joints can be reduced.

Additionally, the air bubbles and the space between the covering material 10 and the rectangular electric wire 110 are reduced, hence the coil 200 has a high dielectric breakdown voltage, and accordingly, the coil 200 using the covered rectangular electric wire 100 allows a design involving a high applied voltage, and can improve the output power thereof.

Consequently, it is possible to realize the electrical device suppressed in the degradation of the properties thereof.

### Example 1

In present Example, examined was the effect of the condition that the adhesive force of the viscoelastic layer to the self-back surface as measured by peeling at a peeling angle of 180° and a tensile rate of 300 mm/min was 0.05 N/20 mm or more and 10 N/20 mm or less.

### Inventive Example 1

In Inventive Example 1, the covering material 10 was produced according to Embodiment 1. Specifically, 100 parts by weight of “KR-3700” (silicone resin, solid content: 60%, manufactured by Shin-Etsu Chemical Co., Ltd.) as a silicone-based viscoelastic material, 0.5 part by weight of “PL-50T” (manufactured by Shin-Etsu Chemical Co., Ltd.) as a platinum catalyst and 315 parts by weight of toluene as a solvent were mixed together, and the resulting mixture was stirred with a disper to prepare a silicone-based viscoelastic composition. The silicone-based viscoelastic composition was applied with a fountain roll onto “Kapton 40EN” (thickness: 10.0 μm, tensile modulus of elasticity: 5.80 GPa, manufactured by Du Pont-Toray Co., Ltd.) as the backing 11 made of a polyimide resin in such a way that the thickness of the silicone-based viscoelastic composition layer after drying was 3.0 μm, and cured and dried under the conditions of a drying temperature of 150° C. and a drying time of 1 minute, to prepare a covering material 10 in which a viscoelastic layer 12 having a gel fraction of 74% was formed on the backing 11. The obtained covering material 10 was taken up onto a winding core 20 (inner diameter: 76 mm) to yield a roll-shaped wound body shown in FIG. 1.

### Inventive Example 2

Inventive Example 2 was fundamentally the same as Inventive Example 1, but was different from Inventive Example 1 in the viscoelastic layer 12 and in the backing 11. Specifically, 70 parts by weight of “X-40-3229 (silicone rubber, solid content: 60%, manufactured by Shin-Etsu Chemical Co., Ltd.) and 30 parts by weight of “KR-3700” (silicone resin, solid content: 60%, manufactured by Shin-Etsu Chemical Co., Ltd.) as a silicone-based viscoelastic material, 0.5 part by weight of “PL-50T” (manufactured by Shin-Etsu Chemical Co., Ltd.) as a platinum catalyst and 315 parts by weight of toluene as a solvent were mixed together, and the resulting mixture was stirred with a disper to prepare a silicone-based viscoelastic composition. As the backing 11 made of a polyimide resin, “Kapton 50H” (thickness: 12.5 μm, tensile modulus of elasticity: 3.50 GPa, manufactured by Du Pont-Toray Co., Ltd.) was used.

### Inventive Example 3

A covering material 10 was produced in the same manner as in Inventive Example 1 except that a polyethylene terephthalate film “Lumilar S10” (thickness: 12.0 μm, tensile modulus of elasticity: 4 GPa, manufactured by Toray Industries, Inc.) was used as a backing 11.

### Inventive Example 4

To 100 parts of a mixture of n-butyl acrylate:acrylic acid=100:5 (weight ratio), 0.2 part of benzoyl peroxide as a polymerization initiator was added, and the polymerization was performed in toluene to yield a solution (copolymerization solution) containing an acrylic polymer (copolymer) having a weight average molecular weight of 500,000 [polystyrene equivalent molecular weight as measured by Gel Permeation Chromatography (GPC)]. To the copolymerization solution, 4 parts of a polyisocyanate compound (trade name “Coronate L” manufactured by Nippon Polyurethane Industry Co., Ltd.) in relation to 100 parts of the solid content of the copolymer was added, and sufficiently mixed to prepare a viscoelastic composition. The viscoelastic composition was applied with a fountain roll onto “Lumilar S10” (thickness: 25.0 μm, tensile modulus of elasticity: 4 GPa, manufactured by Toray Industries, Inc.) as a backing 11 made of polyethylene terephthalate in such a way the thickness of the viscoelastic composition layer after drying was 15.0 μm, and cured and dried under the conditions of a drying temperature of 120° C. and a drying time of 1 minute, to prepare a covering material 10 in which an acrylic viscoelastic layer having a gel fraction of 45% was formed on the polyethylene terephthalate backing. The obtained covering material 10 was taken up onto a winding core 20 (inner diameter: 76 mm) to yield a roll-shaped wound body.

### Comparative Example 1

The covering material of Comparative Example 1 was fundamentally the same as the covering material of Inventive Example 1, but different from the covering material of Inventive Example 1 in that “Kapton 50H” (thickness: 12.5 μm, manufactured by Du Pont-Toray Co., Ltd.) was used as the backing 11 and no viscoelastic layer was formed.

### Comparative Example 2

A covering material 10 was produced in the same manner as in Inventive Example 2 except that 100 parts by weight of “X-40-3229” (silicone rubber, solid content: 60%, manufactured by Shin-Etsu Chemical Co., Ltd.) as a silicone-based viscoelastic material, 0.5 part by weight of “PL-50T” (manufactured by Shin-Etsu Chemical Co., Ltd.) as a platinum catalyst and 315 parts by weight of toluene as a solvent were mixed together, and the resulting mixture was stirred with a disper to prepare a silicone-based viscoelastic composition.

### Comparative Example 3

To 100 parts of a mixture of n-butyl acrylate:acrylic acid=100:5 (weight ratio), 0.2 part of benzoyl peroxide as a polymerization initiator was added, and the polymerization was performed in toluene to yield a solution (copolymerization solution) containing an acrylic polymer (copolymer) having a weight average molecular weight of 500,000 [polystyrene equivalent molecular weight as measured by Gel Permeation Chromatography (GPC)]. To the copolymerization solution, 20 parts of a phenolic resin as a tackifier, 30 parts of a xylene-based resin and 2 parts of a polyisocyanate compound (trade name “Coronate L” manufactured by Nippon Polyurethane Industry Co., Ltd.) in relation to 100 parts of the solid content of the copolymer were added, and sufficiently mixed to prepare a viscoelastic composition. The viscoelastic composition was applied with a fountain roll onto a backing “Lumilar S10” (thickness: 12.0 μm, tensile modulus of elasticity: 4 GPa, manufactured by Toray Industries, Inc.) made of polyethylene terephthalate in such a way that the thickness of the viscoelastic composition layer after drying was 30.0 μm, and cured and dried under the conditions of a drying temperature set at 120° C. and a drying time of 1 minute, to prepare a covering material in which an acrylic viscoelastic layer having a gel fraction of 35% was formed on the backing made of polyethylene terephthalate. The obtained covering material was taken up onto a winding core (inner diameter: 76 mm) to yield a roll-shaped wound body.

(Evaluation Methods)

For each of Inventive Examples 1 to 4 and Comparative Examples 1 to 3, the adhesive force of the viscoelastic layer to the self-back surface (the adhesive force to the self-back surface), the adhesive force of the viscoelastic layer to the SUS304 steel plate and the partial discharge onset voltage were respectively measured, and at the same time the detachment was evaluated. The results thus obtained are shown in Table 1.

(Measurement of Adhesive Force to Self-Back Surface)

Each of the covering materials 10 produced in Inventive Examples 1 to 4 and Comparative Example 2 was cut to a width of 20 mm and a length of 150 mm to prepare a first evaluation sample, and the viscoelastic layer of the thus obtained first evaluation sample was bonded to a stainless steel plate; onto the self-back surface (the lower surface 11b of the backing 11) of the first evaluation sample, the viscoelastic layer of a second evaluation sample (20 mm in width and 150 mm in length) prepared from the same covering material as that for the first evaluation sample was bonded in an atmosphere of 23° C. and 50% RH with the aid of a back and forth movement of a 2-kg roller to prepare a bonded set of the first and second evaluation samples. After a curing at 23° C. for 30 minutes, a peeling test was performed for the bonded set of the first and second evaluation samples by using the universal tensile tester “TCM-1kNB” manufactured by Minebea Co., Ltd., at a peeling angle of 180° and a tensile rate of 300 mm/min to measure the adhesive force to the self-back surface. The adhesive force to the self-back surface thus obtained for each of the covering materials 10 produced in Inventive Examples 1 to 4 and Comparative Example 2 are shown in Table 1 presented below.

(Measurement of Adhesive Force to SUS304 Steel Plate)

Each of the covering materials 10 produced in Inventive Examples 1 to 4 and Comparative Example 2 was cut to a width of 20 mm and a length of 150 mm to prepare an evaluation sample. The viscoelastic layer of each of the evaluation samples was bonded to a SUS304 steel plate in an atmosphere of 23° C. and 50% RH with the aid of a back and forth movement of a 2-kg roller. After a curing at 23° C. for 30 minutes, a peeling test was performed for each of the bonded evaluation samples by using the universal tensile tester “TCM-1kNB” manufactured by Minebea Co., Ltd., at a peeling angle of 180° and a tensile rate of 300 mm/min to measure the adhesive force to the SUS304 steel plate. The adhesive forces to the SUS304 steel plate thus obtained for the evaluation samples of Inventive Examples 1 to 4 and Comparative Example 2 are shown in Table 1 presented below.

(Evaluation of Detachment)

From each of the covering materials produced in Examples 1 to 4 and

Comparative Examples 1 and 2, a specimen of 5 mm in width was prepared. The specimen was spirally wound around a rectangular electric wire, “Di-BSCCO” (wire: bismuth-based superconducting wire, 0.23 mm in thickness×4.3 mm in width, manufactured by Sumitomo Electric Industries, Ltd.) at a winding angle (the angle θ in FIG. 4) of 20 degrees with the overlap (the width W120 of the lap portion 120 in FIG. 5) of the covering material with itself of approximately 1.5 mm (30% of the width W10 of the rectangular electric wire) to prepare a spirally covered evaluation sample of 10 cm in length. By visual observation of the evaluation samples, the occurrence/non-occurrence of the detachment of each of the covering materials was examined. The detachment as referred to herein means the condition that a space or air bubbles are formed between the covering material and the rectangular electric wire. The results thus obtained are shown in Table 1 presented below. In Table 1, the case where no detachment was found is marked with “◯” and the case where the detachment was found is marked with “x”.

(Measurement of Partial Discharge Onset Voltage)

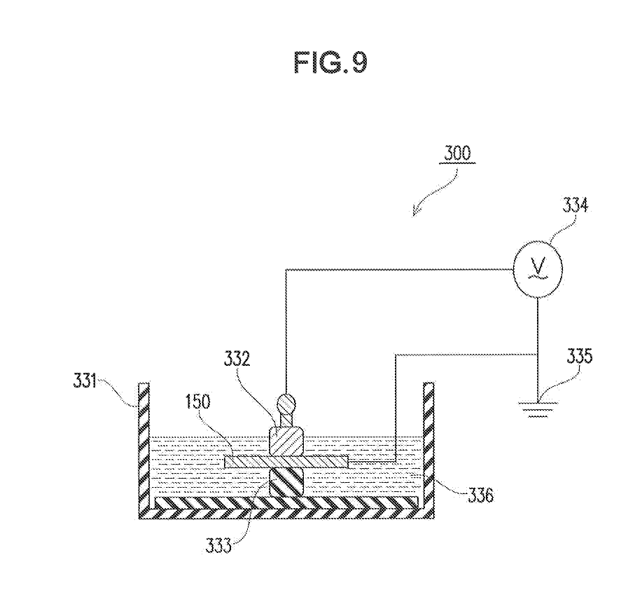

The detachment evaluation samples were used as the evaluation samples of the partial discharge onset voltage measurement, and the partial discharge onset voltage in liquid nitrogen was measured for each of the evaluation samples with a measurement apparatus 300 shown in FIG. 9.

Specifically, in FIG. 9, an evaluation sample 150 was disposed in a vessel 331 in a manner sandwiching the evaluation sample 150 with an electrode 332 and a supporting post 333. A partial discharge measurement apparatus 334 was connected to an upper electrode 332, and a ground wire 335 was connected to the rectangular electric wire of the evaluation sample 150. Then, liquid nitrogen 336 was added so as for at least the evaluation sample 150 to be immersed in liquid nitrogen, and under the condition that the temperature was stabilized (after an elapsed time of approximately 15 minutes), the measurement of the partial discharge onset voltage was started.

The size of the electrode 332 was as follows: 25 mmφ, R 2.5 mm and the contact area 20 mmφ. When the voltage was increased at a voltage increase rate of 200 Vrms/sec, the applied voltage when the discharge of a discharge amount of 100 pC or more occurred at a rate of 50 PPS (the number of the occurrence of discharge per unit time) or more was taken as the partial discharge onset voltage. The results thus obtained are shown in Table 1 presented below.

In Table 1, the case where the partial discharge onset voltage was 280 Vrms or more is marked with “◯,” and the case where the partial discharge onset voltage was less than 280 Vrms is marked with “x.”

(Measurement of Dielectric Breakdown Voltage)

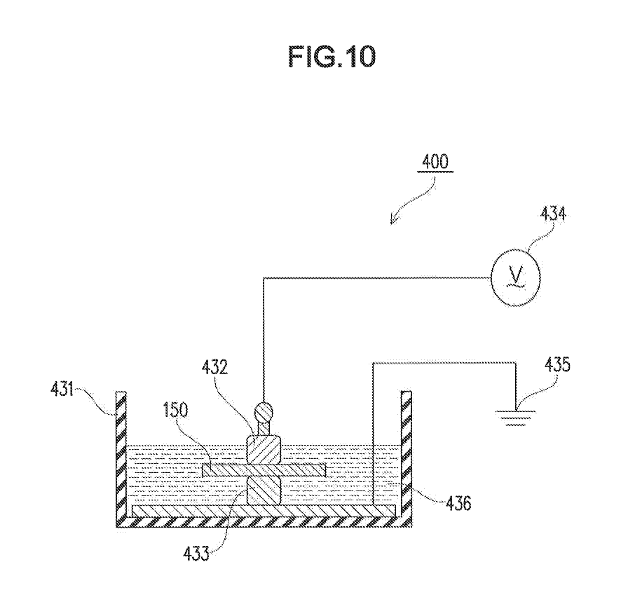

The detachment evaluation samples were used as the evaluation samples of the dielectric breakdown voltage measurement, and the dielectric breakdown voltage in liquid nitrogen was measured for each of the evaluation samples with a measurement apparatus 400 shown in FIG. 10 according to JIS C 2110.

Specifically, in FIG. 10, an evaluation sample 150 was disposed in a vessel 431 in a manner sandwiching the evaluation sample 150 with electrodes 432 and 433. A withstand voltage test apparatus 434 was connected to the upper electrode 432 and a ground wire 435 was connected to the lower electrode 433. Then, liquid nitrogen was added so as for at least the evaluation sample 150 to be immersed in liquid nitrogen, and under the condition that the temperature was stabilized (after an elapsed time of approximately 15 minutes), the measurement of the dielectric breakdown voltage was started.

The size of each of the electrodes 432 and 433 was as follows: 25 mmφ, R 2.5 mm and the contact area 20 mmφ. When the voltage was increased at a voltage increase rate of AC 250 Vrms/sec, the voltage value when the evaluation sample 150 underwent dielectric breakdown (the leak current threshold value: 50 mA) was defined as the dielectric breakdown voltage.

(Evaluation Results)

TABLE 1

| | Inventive | Inventive | Inventive | Inventive | C. | C. | C. |
|---|---|---|---|---|---|---|---|
| | Exam. 1 | Exam. 2 | Exam. 3 | Exam. 4 | Exam. 1 | Exam. 2 | Exam. 3 |
| Type of backing | PI | PI | PET | PET | PI | PI | PET |
| Thickness of backing [μm] | 10.0 | 12.5 | 12.0 | 25.0 | 12.5 | 12.5 | 12.0 |
| Type of viscoelastic layer | Si(0/100) | Si(70/30) | | Acrylic | None | Si(100/0) | Acrylic, |
| | | | | | | | strongly |
| | | | | | | | adhesive |
| Thickness of viscoelastic | 3.0 | | | 15.0 | — | 3.0 | 30.0 |
| layer [μm] | | | | | | | |
| Adhesive force to self-back | 2.1 | 1.7 | 0.2 | 3.6 | — | 0.02 | 11 |
| surface [N/20 mm] | | | | | | | |
| Adhesive force [N/20 mm] | 3.4 | 2.5 | 0.28 | 5.9 | — | 0.03 | 12 |
| Winding angle [degrees] | 20 | | | | | | |
| Overlap width [%] | 30 | | | | | | |
| Evaluation of detachment | ∘ | ∘ | ∘ | ∘ | x | x | Evaluation |
| | | | | | | | was |
| | | | | | | | impossible |
| Partial discharge onset | 580 | 660 | 650 | 700 | 270 | 300 | Evaluation |
| voltage [Vrms] | | | | | | | was |
| | | | | | | | impossible |
| Dielectric breakdown | 3.6 | 4.2 | 4.0 | 5.1 | 3.2 | 3.3 | Evaluation |
| voltage [kV] | | | | | | | was |
| | | | | | | | impossible |

As shown in Table 1, in Inventive Examples 1 to 4 in which the adhesive force of the viscoelastic layer 12 to the self-back surface as measured by peeling at a peeling angle of 180° and a tensile rate of 300 mm/min was 0.05 N/20 mm or more and 10 N/20 mm or less, no detachment was observed, the partial discharge onset voltage was 580 Vrms or more, the dielectric breakdown voltage was 3.6 kV or more, and thus high properties were able to be maintained.

On the other hand, in Comparative Example 1 lacking the viscoelastic layer, there was absolutely no feeling of adhesion, so that no evaluation sample was able to be prepared, and accordingly, neither the adhesive force to the self-back surface nor the adhesive force to the SUS304 steel plate was able to be measured. Consequently, in Comparative Example 1, the partial discharge onset voltage and the dielectric breakdown voltage were both low, and the properties were low.

In Comparative Example 2, in which the adhesive force of the viscoelastic layer 12 to the lower surface 11b of the backing 11 as measured by peeling at a peeling angle of 180° and a tensile rate of 300 mm/min was less than 0.05 N/20 mm, the adhesive force to the self-back surface was low, and hence the detachment was observed, the partial discharge onset voltage and the dielectric breakdown voltage were both low, and the properties were low.

In Comparative Example 3, in which the adhesive force of the viscoelastic layer 12 to the lower surface 11b of the backing 11 as measured by peeling at a peeling angle of 180° and a tensile rate of 300 mm/min exceeded 10 N/20 mm, the adhesive force to the self-back surface was too large, and hence when the rectangular electric wire was covered by unreeling from the roll-shaped wound body, the unreeling force was large and the unreeling rate was not stable. Consequently, no evaluation sample of the covered rectangular electric wire was able to be prepared.

From what has been described above, it has been verified that according to the present example, in the covering material, the adhesive force of the viscoelastic layer to the self-back surface as measured by peeling at a peeling angle of 180° and a tensile rate of 300 mm/min was 0.05 N/20 mm or more and 10 N/20 mm or less, and consequently when a rectangular electric wire is covered with the covering material, the degradation of the properties of the covered rectangular electric wire can be suppressed.

It has also been verified that in the covered rectangular electric wire, the rectangular electric wire is covered with the covering material including the viscoelastic layer in which the adhesive force of the viscoelastic layer to the self-back surface is 0.05 N/20 mm or more and 10 N/20 mm or less, and hence the degradation of the properties of the covered rectangular electric wire is suppressed.

### Example 2

In present Example, further examined was the effect produced by the configuration in which the adhesive force of the viscoelastic layer to the self-back surface as measured by peeling at a peeling angle of 180° and a tensile rate of 300 mm/min was 0.05 N/20 mm or more and 10 N/20 mm or less.

In present Example, the covering materials of Inventive Examples 1 to 4 and Comparative Examples 1 and 2 were produced. From each of the covering materials produced in Examples 1 to 4 and Comparative Examples 1 and 2, a specimen of 5 mm in width was prepared. The specimen was spirally wound around a rectangular electric wire, “Di-BSCCO” (wire: bismuth-based superconducting wire, 0.23 mm in thickness×4.3 mm in width, manufactured by Sumitomo Electric Industries, Ltd.) at a winding angle (the angle θ in FIG. 4) of 60 degrees with the overlap (the width W120 of the lap portion 120 in FIG. 4) of the covering material with itself of approximately 2.0 mm (40% of the width of the specimen) to prepare a spirally covered evaluation sample of 10 cm in length, and for the evaluation sample, in the same manner as in Example 1, the detachment was observed, and the partial discharge onset voltage and the dielectric breakdown voltage were measured. The results thus obtained are shown in Table 2 presented below.

(Evaluation Results)

TABLE 2

| | Inventive | Inventive | Inventive | Inventive | C. | C. |
|---|---|---|---|---|---|---|
| | Exam. 1 | Exam. 2 | Exam. 3 | Exam. 4 | Exam. 1 | Exam. 2 |
| Type of backing | PI | PI | PET | PET | PI | PI |
| Thickness of backing [μm] | 10.0 | 12.5 | 12.0 | 25.0 | 12.5 | 12.5 |
| Type of viscoelastic layer | Si(0/100) | Si(70/30) | | Acrylic | None | Si(100/0) |
| Thickness of viscoelastic | 3.0 | | | 15.0 | — | 3.0 |
| layer [μm] | | | | | | |
| Adhesive force to self-back | 2.1 | 0.17 | 0.20 | 3.6 | — | 0.02 |
| surface [N/20 mm] | | | | | | |
| Adhesive force [N/20 mm] | 3.4 | 0.25 | 0.28 | 5.9 | — | 0.03 |
| Winding angle [degrees] | 60 | | | | | |
| Overlap width [%] | 40 | | | | | |
| Evaluation of detachment | ∘ | ∘ | ∘ | ∘ | ∘ | ∘ |
| Partial discharge onset | 620 | 700 | 690 | 760 | 300 | 630 |
| voltage [Vrms] | | | | | | |
| Dielectric breakdown | 4.1 | 4.8 | 4.5 | 5.7 | 3.3 | 4.0 |
| voltage [kV] | | | | | | |

As shown in Table 2, in Example 2 in which the winding angle was set to be large and the overlap width was set to be large, the detachment was able to be reduced as compared to the detachment in Example 1. Consequently, in the case where the winding angle was set to be large and the overlap width was set to be large, even when the adhesive force of the viscoelastic layer to the self-back surface was small, the properties of the covered rectangular electric wire was able to be improved. However, when the winding angle was set to be large and the overlap width was set to be large, the length of the rectangular electric wire which was able to be covered with a single piece of the covering material was short. From consideration of the results of Example 1 and the results of Example 2 in combination, it has been found that owing to the fact that the adhesive force of the viscoelastic layer to the self-back surface as measured by peeling at a peeling angle of 180° and a tensile rate of 300 mm/min is 0.05 N/20 mm or more and 10 N/20 mm or less, even when the winding angle and the overlap width are set to be small, it is possible to maintain the high properties of the covered rectangular electric wire.

From what has been described above, according to present Example, it has been able to be verified that owing to the fact that the adhesive force of the viscoelastic layer to the self-back surface as measured by peeling at a peeling angle of 180° and a tensile rate of 300 mm/min is 0.05 N/20 mm or more and 10 N/20 mm or less, it is possible to realize the covering material, capable of suppressing the degradation of the properties of the covered rectangular electric wire obtained by covering a rectangular electric wire with the covering material and at the same time, capable of covering the rectangular electric wire over an extended length.

As described above, Embodiments and Examples of the present invention have been described. Appropriate combinations of the features of the individual

Embodiments and individual Examples are also anticipated from the very beginning. Embodiments and Examples disclosed this time are presented for the purpose of exemplification, and should be construed as non-limiting. The scope of the present invention is defined by the appended claims rather than foregoing Embodiments and Examples, and all the modifications in the meanings and the scope equivalent to the claims are intended to be included.

What is claimed is:

1. A covering material comprising:
a backing having an upper surface and a lower surface opposite to the upper surface; and
a viscoelastic layer formed on the upper surface of the backing,
wherein the covering material is a covering material for covering a rectangular electric wire; and
an adhesive force of the viscoelastic layer to the lower surface of the backing as measured by peeling at a peeling angle of 180° and a tensile rate of 300 mm/min is 0.05 N/20 mm or more and 10 N/20 mm or less.

2. The covering material according to claim 1, wherein the viscoelastic layer contains a silicone-based viscoelastic composition.

3. The covering material according to claim 1, wherein the backing has a thickness of 5.0 μm or more and 25.0 μm or less.

4. A covered rectangular electric wire comprising:
the covering material according to claim 1; and
a rectangular electric wire covered with the covering material.

5. The covered rectangular electric wire according to claim 4, wherein the rectangular electric wire is a superconducting wire.

6. An electrical device produced by using the covered rectangular electric wire according to claim 4.
